(19) United States
(12) Patent Application Publication
(10) Pub. No.: US 2015/0153466 A1
(43) Pub. Date: Jun. 4, 2015

(54) Source Start Time Determination

(71) Applicant: WesternGeco L.L.C., Houston, TX (US)

(72) Inventor: Timothy James Dean, Winchester (GB)

(21) Appl. No.: 14/559,768

(22) Filed: Dec. 3, 2014

Related U.S. Application Data
(60) Provisional application No. 61/911,900, filed on Dec. 4, 2013.

(51) Int. Cl. G01V 1/22

(52) U.S. Cl. CPC G01V 1/22

(57) ABSTRACT

Various implementations described herein are directed to a method of performing a land seismic survey operation. The method may include receiving a first information from a central recording system by a computer system on a seismic truck. The first information describes time and locations of seismic shots being performed in the seismic survey operation. The method may include using a set of rules and the first information to determine a start time for a seismic shot at a next shot location. The method may also include transmitting a second information that describes the next shot location and the start time to the central recording system.

### CROSS-REFERENCE TO RELATED APPLICATIONS

This application claims the benefit of U.S. Provisional Patent Application Ser. No. 61/911,900, filed Dec. 4, 2013, titled METHOD FOR INITIATING SOURCES AS PART OF A SEISMIC SURVEY, and the disclosure of which is incorporated herein by reference.

### BACKGROUND

### Discussion of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Seismic exploration involves surveying subterranean geological formations for hydrocarbon deposits. A survey typically involves deploying seismic sources and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones) and others are sensitive to particle motion (e.g., geophones). Industrial surveys may deploy only one type of sensors or both. In response to the detected seismic events, the sensors generate electrical signals to produce seismic data. Analysis of the seismic data can then indicate the presence or absence of probable locations of hydrocarbon deposits.

One type of seismic source is a seismic vibrator, which is used in connection with a “vibroseis” survey. For a seismic survey that is conducted on dry land, the seismic vibrator imparts a seismic signal into the earth. Typically, the seismic vibrator is part of a seismic truck. The seismic truck stops at various locations and generates seismic waves, referred to as performing a shot, at each location.

### SUMMARY

Described herein are implementations of various technologies for a method for performing a land seismic survey operation. The method may include receiving a first information from a central recording system by a computer system on a seismic truck. The first information describes times and locations of seismic shots being performed in the seismic survey operation. The method may include using a set of rules and the first information to determine a start time for a seismic shot at a next location. The method may also include transmitting a second information that describes the next shot location and the start time to the central recording system.

Described herein are also implementations of various technologies for a method for performing a land seismic survey operation. The method may include receiving a plurality of information from a plurality of seismic trucks that describe times and locations of seismic shots being performed by the plurality of seismic trucks. The method may include using a set of rules and the plurality of information to determine a start time at a next shot location. The start time is determined using a computer system on a seismic truck. The method may also include transmitting a description of the next shot location and start time from the seismic truck to the plurality of seismic trucks.

Described herein are also implementations of various technologies for a seismic truck having a computer system. The computer system includes one or more processors and memory. The memory has a plurality of executable instructions. When the executable instructions are executed by the processor, the processor may receive transmissions describing times and locations of seismic shots performed by other seismic trucks as part of a seismic survey operation. The processor may analyze the times and locations of seismic shots performed by other seismic trucks using a set of rules to determine a start time for a seismic shot at a next shot location. The processor may also transmit a description of the next shot location and start time.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a vibroseis seismic survey truck in accordance with implementations of various techniques described herein.

FIG. 2 is a flow diagram of a method for performing a seismic survey in accordance with implementations of various techniques described herein.

FIG. 3A illustrates a graph of shot times with centralized decision making in connection with implementations of various techniques described herein.

FIG. 3B illustrates a graph of shot times with source decision making in accordance with implementations of various techniques described herein.

FIG. 4 illustrates a schematic diagram of a computing system in which the various technologies described herein may be incorporated and practiced.

### DETAILED DESCRIPTION

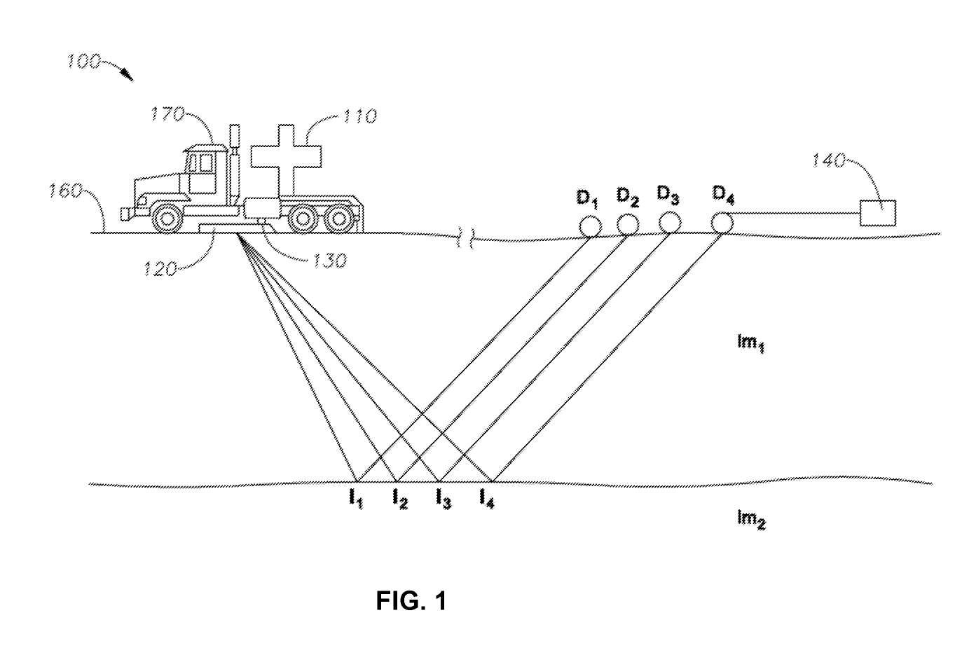

Various implementations described herein will now be described in more detail with reference to FIGS. 1-4.

FIG. 1 illustrates a vibroseis seismic survey truck in accordance with various implementations described herein. In the illustrated system, a seismic vibrator 100 includes a vibrating element 110, a baseplate 120 and a signal measuring apparatus 130, which may be for example, a plurality of accelerometers whose signals are combined to measure the actual ground-force signal applied to the earth by the seismic vibrator. The seismic vibrator 100 illustrated in FIG. 1 may be constructed on a truck 170 that provides for maneuverability of the system. As illustrated, the vibrating element 110 may be coupled with the baseplate 120 to provide for the transmission of vibrations from the vibrating element 110 to the baseplate 120. The baseplate 120 may be positioned in contact with an earth surface 160 and the vibrations of the vibrating element 110 may be communicated into the earth surface 160.

The seismic signal that is generated by the vibrating element 110 and emitted into the earth, via the baseplate 120, may be reflected off the interface between subsurface impedances Im₁ and Im₂ at points I₁, I₂, I₃, and I₄. This reflected signal may be detected by geophones D₁, D₂, D₃, and D₄, respectively. The signals generated by the vibrating element 110 on the truck 100 may also be transmitted to a data storage 140 for combination with raw seismic data received from geophones D₁, D₂, D₃, and D₄ to provide for processing of the raw seismic data. In operation, a control signal, referred to also as pilot sweep, causes the vibrating element 110 to exert a variable pressure on the baseplate 120.

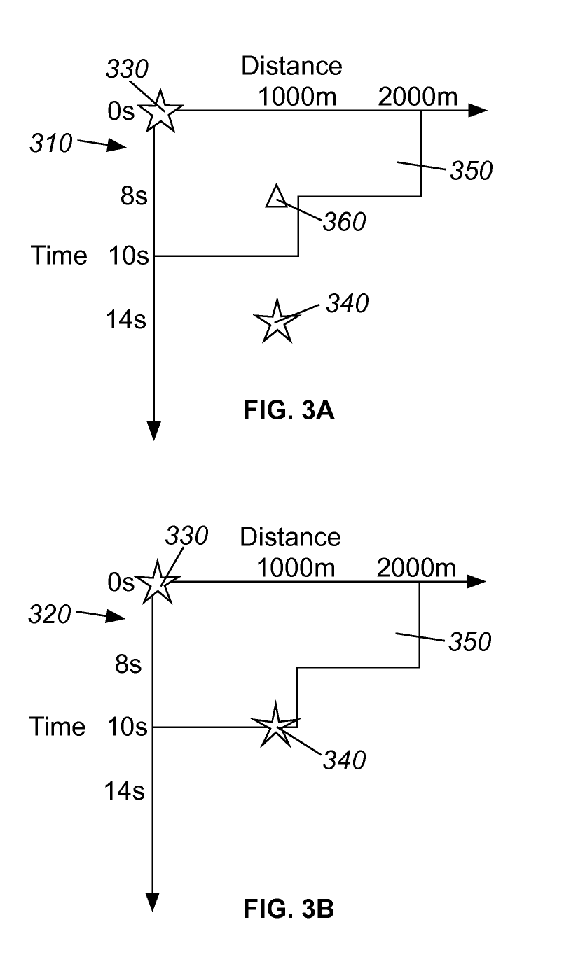

During a seismic survey, the truck 170 travels to a series of set locations, and then stops at the individual locations to perform a shot at a start time. Traditionally, in order to receive a start time, a radio system on the truck 170 transmits a ‘ready tone’ to a central recording system, also known as an acquisition system, when the truck 170 is ready to perform a shot. In one implementation, the central recording system is located on a recording truck. The central recording system then transmits a start time to the truck 170, or a start signal indicating that the truck 170 should start, and the truck 170 performs a shot at the start time or upon receiving the start signal. For various reasons, further described in FIGS. 3A and 3B, this call and response method of determining a start time may lead to inefficiencies.

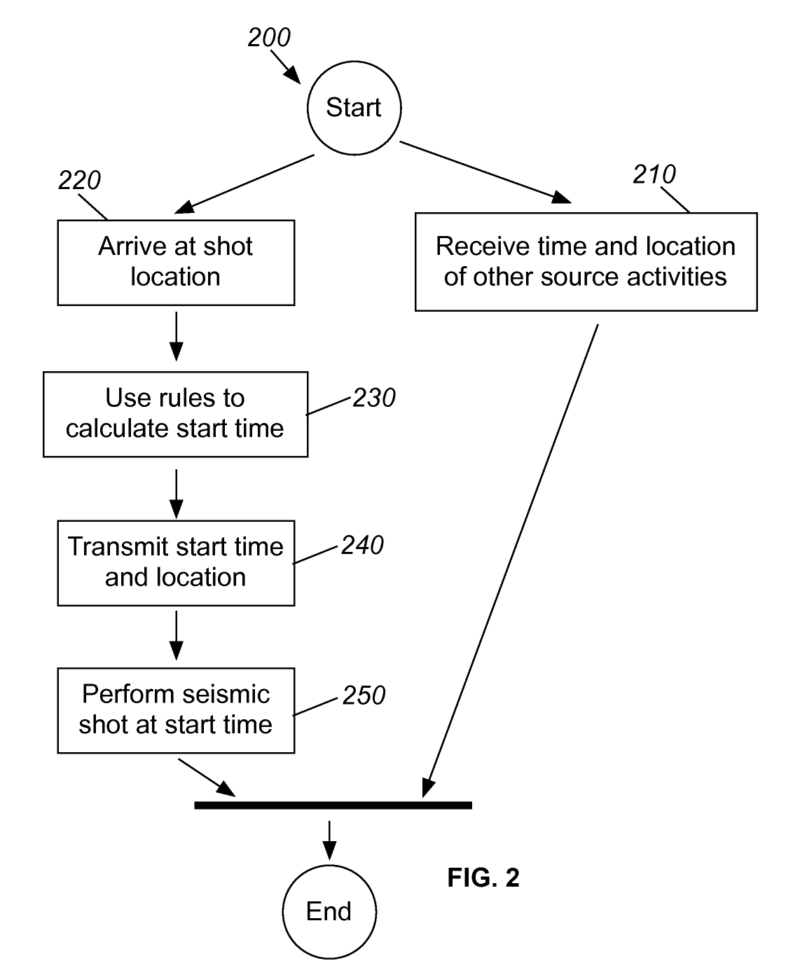

FIG. 2 is a flow diagram of a method for performing a seismic survey in accordance with implementations of various techniques described herein. In one implementation, method 200 may be performed by a computer system 400. It should be understood that while method 200 indicates a particular order of execution of operations, in some implementations, certain portions of the operations might be executed simultaneously, in a different order, or on different systems. For example, block 210 may be performed simultaneously with blocks 220-250. Further, in some implementations, additional operations or steps may be added to the method 200. Likewise, some operations or steps may be omitted.

At block 210, a seismic truck that is part of a seismic survey operation receives a description of the start times and location of shots performed by other seismic trucks that are also part of the seismic survey operation. The seismic truck may also receive source numbers that correspond to the shots. The time, location and source number may be received in an encrypted or encoded form. The description of the time and location of a shot may be received prior to, during, or after the shot. The location may be a location measured by a Global Positioning System (GPS), or may be a source point location. A source point location is a location that is set when planning a seismic survey.

In one implementation, the location and start time may be transmitted to a plurality of other seismic trucks. In a second implementation, the location and start time may be transmitted to a central recording system, and the central recording system may then transmit the location and start time to other seismic trucks that are part of the seismic survey operation. The result of block 210 is that the trucks that are part of the seismic survey operation know the location and shot time of the seismic shots being performed as part of the seismic survey. In one implementation, a truck may only receive records of shots that occur within a set distance of that truck.

Block 210 may be performed repeatedly throughout a seismic survey. For example, a seismic truck may receive data from other seismic trucks one or more times while performing blocks 220-250. In one implementation, the data received at block 210 may be stored in a database. For example, the data received at block 210 may be stored in a database on a computer system located on the seismic truck.

At block 220, a seismic truck performing method 200 arrives at a shot location. The shot location may be a set or predetermined location in a seismic survey plan. The arrival may be determined using a GPS device.

At block 230, the seismic truck uses rules to calculate a start time for performing a seismic shot. The rules may be specific to a seismic survey. The rules may describe the amount of time required between seismic shots, which may be based on distance between shot locations. For example, the rules may state that 7 seconds are to elapse between shots that are 1000 meters or less distance apart, that 3 seconds are to elapse between shots that are between 1000 and 3000 meters apart, and that 1 second is to elapse between shots that are greater than 3000 meters apart.

The rules may be based on the rate at which seismic signals dissipate within the earth. The amount of time between shots may be calculated based on a selected data quality. For example, if the time between shots is greater, then noise in the measured response may be reduced and the quality of the measured data will improve.

At block 240, the start time calculated at block 230 and location of the shot are transmitted to a central recording system, other seismic trucks, or both. The start time and location may be transmitted using a radio. The start time and location may be transmitted in an encrypted or encoded format. In addition to the start time and location, a source number may be transmitted to the central recording system. The source number may identify the seismic truck that is transmitting the start time and location.

At block 250, the seismic truck may perform a seismic shot at the location and start time transmitted at block 240. In one implementation, block 240 is performed prior to block 250. In another implementation, block 240 and block 250 are performed simultaneously. In yet another implementation, block 240 is performed after block 250.

After performing the seismic shot at block 250, the seismic truck may move to another shot location, and repeat block 220 through 250. Throughout this process, the seismic truck may simultaneously be performing block 210.

FIG. 3A illustrates a graph 310 of shot times with centralized decision making in connection with implementations of various techniques described herein. In graph 310, a central recording system transmits a start time to seismic sources 330 and 340 after receiving a ‘ready tone’ 360. A first seismic shot 330 is performed at a time of zero seconds and at a location of zero meters. The location and start time of the first shot are recorded by the central recording system. The area 350 represents the rules for the seismic survey being performed in graph 310. That is, after the first shot 330, in order to follow the rules, any subsequent seismic shot is to be performed outside of the area 350. In graph 310, the rules specifically indicate that any subsequent shot within 1000 meters of the first shot 330 should be performed after 10 seconds has elapsed following the first shot 330. The rules also state that any subsequent shot that is greater than 1000 meters and less than 2000 meters from the first shot 330 may be performed after 8 seconds has elapsed following the first shot 330. Thus, as can be seen in the figure, a second shot 340 at a distance of approximately 950 meters may be performed at any time after 10 seconds has elapsed following the first shot 330.

After the first shot 330 has been performed, a seismic truck ready to perform a second shot at a distance of 950 meters from the location of the first shot transmits a ‘ready tone’ 360 to a central recording system. It should be noted that although the ‘ready tone’ is illustrated as having a location on the graph 310, the ‘ready tone’ is a signal transmitted by a truck at that location. The central recording system examines the prior shot data and the rules to determine a start time for the second shot 340. The central recording system then transmits a start time for a second shot 340 of 14 seconds. Then, the second shot 340 is performed. Although the second shot could be performed at a time of 10 seconds, the transmission time and processing time in this implementation results in a delay, thus causing the second shot to be performed at a time of 14 seconds. Thus, there is 4 seconds of inefficiency in this example.

FIG. 3B illustrates a graph 320 of shot times with source decision making in accordance with implementations of various techniques described herein. In graph 320, the seismic trucks use method 200 to determine a start time. In this figure, rather than a central recording system determining start times, computer systems on the individual trucks determine the start times. In graph 320, the second shot 340 is performed at or near 10 seconds later than the first shot 330. As can be seen, without the delay inherent in transmitting a ‘ready tone’ to a central recording system and receiving a start time from the central recording system, the second shot 340 is performed with less delay than in graph 310.

### Computing System

Implementations of various technologies described herein may be operational with numerous general purpose or special purpose computing system environments or configurations. Examples of well-known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, cloud computing systems, virtual computers, and the like.

The various technologies described herein may be implemented in the general context of computer-executable instructions, such as program modules, being executed by a computer. Generally, program modules include routines, programs, objects, components, data structures, etc. that perform particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

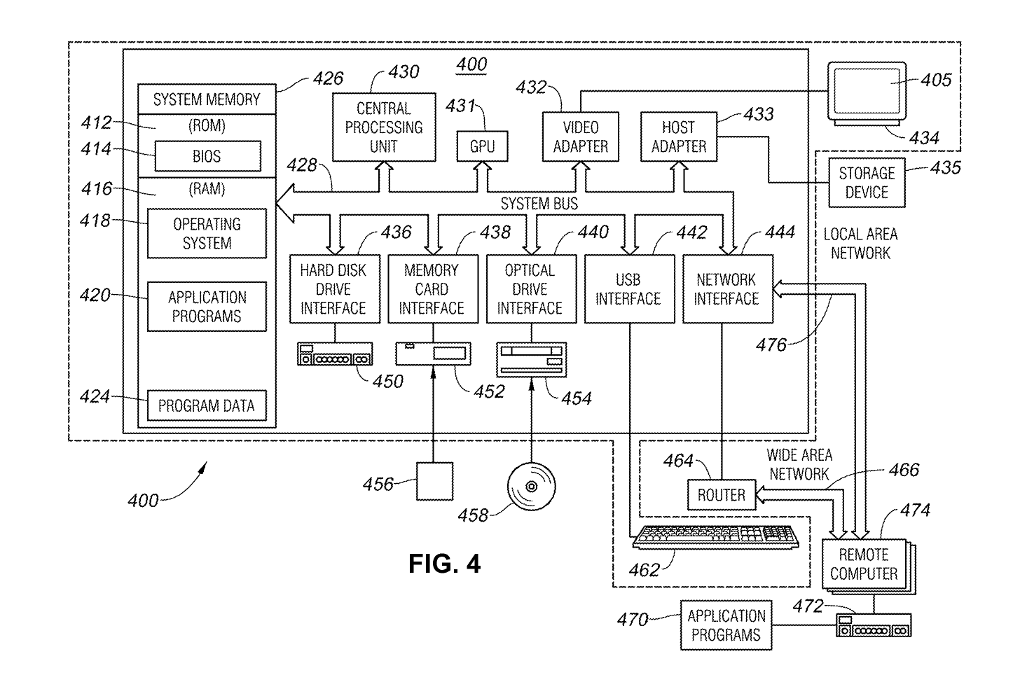

FIG. 4 illustrates a computer system 400 into which implementations of various technologies and techniques described herein may be implemented. Computing system 400 may be a conventional desktop, a handheld device, a wearable device, a controller, a server computer, an electronic device/instrument, a laptop, or a tablet. It should be noted, however, that other computer system configurations may be used.

The computing system 400 may include a central processing unit (CPU) 430, a system memory 426 and a system bus 428 that couples various system components including the system memory 426 to the CPU 430. Although only one CPU 430 is illustrated in FIG. 4, it should be understood that in some implementations the computing system 400 may include more than one CPU 430.

The CPU 430 can include a microprocessor, a microcontroller, a processor, a programmable integrated circuit, or a combination thereof. The CPU 430 can comprise an off-the-shelf processor such as a Reduced Instruction Set Computer (RISC), including an Advanced RISC Machine (ARM) processor, or a Microprocessor without Interlocked Pipeline Stages (MIPS) processor, or a combination thereof. The CPU 430 may also include a proprietary processor. The CPU may include a multi-core processor.

The CPU 430 may provide output data to a Graphics Processing Unit (GPU) 431. The GPU 431 may generate graphical user interfaces that present the output data. The GPU 431 may also provide objects, such as menus, in the graphical user interface. A user may provide inputs by interacting with the objects. The GPU 431 may receive the inputs from interaction with the objects and provide the inputs to the CPU 430. In one implementation, the CPU 430 may perform the tasks of the GPU 431. A video adapter 432 may be provided to convert graphical data into signals for a monitor 434. The monitor 434 includes a screen 405. The screen 405 can be sensitive to heat or touching (now collectively referred to as a “touch screen”). In one implementation, the computer system 400 may not include a monitor 434.

The GPU 431 may be a microprocessor specifically designed to manipulate and implement computer graphics. The CPU 430 may offload work to the GPU 431. The GPU 431 may have its own graphics memory, and/or may have access to a portion of the system memory 426. As with the CPU 430, the GPU 431 may include one or more processing units, and each processing unit may include one or more cores.

The system bus 428 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 426 may include a read only memory (ROM) 412 and a random access memory (RAM) 416. A basic input/output system (BIOS) 414, containing the basic routines that help transfer information between elements within the computing system 400, such as during start-up, may be stored in the ROM 412. The computing system may be implemented using a printed circuit board containing various components including processing units, data storage memory, and connectors.

The computing system 400 may further include a hard disk drive 436 for reading from and writing to a hard disk 450, a memory card reader 452 for reading from and writing to a removable memory card 456 and an optical disk drive 454 for reading from and writing to a removable optical disk 458, such as a CD ROM, DVD ROM or other optical media. The hard disk drive 450, the memory card reader 452 and the optical disk drive 454 may be connected to the system bus 428 by a hard disk drive interface 436, a memory card interface 438 and an optical drive interface 440, respectively. The drives and their associated computer-readable media may provide nonvolatile storage of computer-readable instructions, data structures, program modules and other data for the computing system 400.

Although the computing system 400 is described herein as having a hard disk 450, a removable memory card 456 and a removable optical disk 458, it should be appreciated by those skilled in the art that the computing system 400 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, including a Solid State Disk (SSD), CD-ROM, digital versatile disks (DVD), or other optical storage, magnetic cassettes, magnetic tape, magnetic disk storage or other magnetic storage devices, or any other medium which can be used to store the desired information and which can be accessed by the computing system 400. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. The computing system 400 may also include a host adapter 433 that connects to a storage device 435 via a small computer system interface (SCSI) bus, a Fiber Channel bus, an eSATA bus, or using any other applicable computer bus interface. The computing system 400 can also be connected to a router 464 to establish a wide area network (WAN) 466 with one or more remote computers 474. The router 464 may be connected to the system bus 428 via a network interface 444. The remote computers 474 can also include hard disks 472 that store application programs 470.

In another implementation, the computing system 400 may also connect to one or more remote computers 474 via local area network (LAN) 476 or the WAN 466. When using a LAN networking environment, the computing system 400 may be connected to the LAN 476 through the network interface or adapter 444. The LAN 476 may be implemented via a wired connection or a wireless connection. The LAN 476 may be implemented using Wi-Fi technology, cellular technology, or any other implementation known to those skilled in the art. The network interface 444 may also utilize remote access technologies (e.g., Remote Access Service (RAS), Virtual Private Networking (VPN), Secure Socket Layer (SSL), Layer 2 Tunneling (L2T), or any other suitable protocol). These remote access technologies may be implemented in connection with the remote computers 474. It will be appreciated that the network connections shown are exemplary and other means of establishing a communications link between the computer systems may be used. The network interface 444 may also include digital cellular networks, Bluetooth, or any other wireless network interface.

A number of program modules may be stored on the hard disk 450, memory card 456, optical disk 458, ROM 412 or RAM 416, including an operating system 418, one or more application programs 420, program data 424 and a database system. The one or more application programs 420 may contain program instructions configured to perform method 200 according to various implementations described herein. The operating system 418 may be any suitable operating system that may control the operation of a networked personal or server computer, such as Windows® XP, Mac OS® X, Unix-variants (e.g., Linux® and BSD®), Android®, iOS®, and the like.

A user may enter commands and information into the computing system 400 through input devices such as a keyboard 462 and pointing device. Other input devices may include a microphone, joystick, satellite dish, scanner, user input button, or the like. These and other input devices may be connected to the CPU 430 through a USB interface 442 coupled to system bus 428, but may be connected by other interfaces, such as a parallel port, Bluetooth or a game port. A monitor 405 or other type of display device may also be connected to system bus 428 via an interface, such as a video adapter 432. In addition to the monitor 434, the computing system 400 may further include other peripheral output devices such as speakers and printers.

The detailed description is directed to certain specific implementations. It is to be understood that the discussion above is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference has been made in detail to various implementations, examples of which are illustrated in the accompanying drawings and figures. In the detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for performing a land seismic survey operation, comprising:
receiving a first information from a central recording system by a computer system on a seismic truck, wherein the first information describes times and locations of seismic shots being performed in the seismic survey operation;
using a set of rules and the first information to determine a start time for a seismic shot at a next shot location; and
transmitting a second information that describes the next shot location and the start time to the central recording system.

2. The method of claim 1, further comprising using the seismic truck to generate seismic signals at the start time and next shot location.

3. The method of claim 1, wherein the start time and next shot location are determined by the computer system located on the seismic truck.

4. The method of claim 1, wherein the second information further comprises a source number.

5. The method of claim 1, wherein the next shot location is selected by a user on the seismic truck.

6. The method of claim 1, wherein the next shot location is determined using a Global Positioning System (GPS) device on the seismic truck.

7. The method of claim 1, wherein the next shot location is in the form of a source point described in a plan for the seismic survey operation or in the form of a latitude and longitude coordinate.

8. The method of claim 1, wherein the first information from the central recording system is in an encoded format.

9. The method of claim 1, wherein the set of rules describes a length of time between seismic shots.

10. The method of claim 9, wherein the length of time is based on a distance between shot locations.

11. The method of claim 1, wherein the second information is transmitted using a radio.

12. A method for performing a land seismic survey operation, comprising:
receiving a plurality of information from a plurality of seismic trucks that describe times and locations of seismic shots being performed by the plurality of seismic trucks;
using a set of rules and the plurality of information to determine a start time at a next shot location, wherein the start time is determined using a computer system on a seismic truck; and
transmitting a description of the next shot location and start time from the seismic truck to the plurality of seismic trucks.

13. The method of claim 12, wherein the set of rules describe an amount of time between seismic shots.

14. The method of claim 12, further comprising using the seismic truck to generate seismic signals at the start time and next shot location.

15. A seismic truck having a computer system comprising:
one or more processors; and
memory having a plurality of executable instructions which, when executed by the one or more processors, cause the one or more processors to:
receive transmissions describing times and locations of seismic shots performed by other seismic trucks as part of a seismic survey operation;
analyze the times and locations of seismic shots performed by other seismic trucks using a set of rules to determine a start time for a seismic shot at a next shot location; and
transmit a description of the next shot location and start time.

16. The seismic truck of claim 15, wherein the next shot location is determined using a Global Positioning System (GPS) device on the seismic truck.

17. The seismic truck of claim 15, wherein the executable instructions further cause the processor to store records of the times and locations of seismic shots performed by other seismic trucks as part of the seismic survey operation in a database.

18. The seismic truck of claim 15, wherein the executable instructions further cause the processor to cause a seismic vibrator on the seismic truck to generate seismic signals at the next shot location beginning at the start time

19. The seismic truck of claim 15, wherein the executable instructions that cause the processor to transmit the description of the next shot location and start time comprise executable instructions that cause the processor to:
encrypt the description of the next shot location and start time; and
cause a radio to transmit the encrypted description of the next shot location and start time.

20. The seismic truck of claim 15, wherein the executable instructions that cause the processor to receive the transmissions describing the times and locations of seismic shots performed by other seismic trucks comprise executable instructions that cause the processor to receive the transmissions directly from the other seismic trucks or from a central recording system.
